(19) United States
(12) Patent Application Publication
(10) Pub. No.: US 2026/0221729 A1
(43) Pub. Date: Jul. 30, 2026

(54) DISTRIBUTION BOARD HAVING DRAWER-TYPE DEVICE PANEL

(71) Applicant: LS ELECTRIC CO., LTD., Anyang-si, Gyeonggi-do (KR)

(72) Inventor: Jongdoo KIM, Anyang-si, Gyeonggi-do (KR)

(21) Appl. No.: 19/139,493

(22) PCT Filed: Dec. 21, 2023
(86) PCT No.: PCT/KR2023/021303

§ 371 Date: Jun. 16, 2025

(30) Foreign Application Priority Data
Feb. 20, 2023 (KR) 10-2023-0022303

(51) Int. Cl. H02B 1/06

(52) U.S. Cl. CPC H02B 1/06

(57) ABSTRACT

A distribution board having a drawer-type device panel according to an embodiment of the present disclosure comprises: a distribution board in which a power device is installed; a drawer part outer case plate which is installed on one surface of the distribution board and has an accommodation part; and a drawer plate inserted into the drawer part outer case plate so as to be able to be opened or closed, wherein a rear surface part of the drawer plate is formed to have a height lower than the height of a front surface part thereof so as to enable the drawer plate to rotate downward in a state where a part of the drawer plate is withdrawn therefrom.

### CROSS-REFERENCE TO RELATED APPLICATIONS

This application is a National Stage of International Application No. PCT/KR2023/021303, filed Dec. 21, 2023, which claims priority to and the benefit of Korean Patent Application No. 10-2023-0022303, filed Feb. 20, 2023, the disclosures of which are incorporated herein by reference in its entirety.

### FIELD

The present disclosure relates to a distribution board having a drawer-type device panel, and more particularly, to a distribution board having a drawer-type device panel that facilitates a wiring work while minimizing an occupied space.

### BACKGROUND

In general, a distribution board is a device used for monitoring, controlling, and protecting a power system. The distribution board accommodates therein various electric devices, such as a circuit breaker, a current transformer, and the like, for driving or controlling a power plant, a substation, etc., driving an electric motor, and the like.

The distribution board allows voltage or current to flow while accommodating various types of devices therein, and detects a fault state when a fault voltage or current occurs, thereby breaking a circuit breaker or providing information to another control device.

In the distribution board, a plurality of compartments are defined to accommodate such devices according to the purpose of use, and each compartment must have shielding and insulating performances prescribed by laws and regulations.

In some embodiments, high-voltage distribution boards tend to provide a plurality of compartments and increase in overall size because large capacities and various types of power equipment or accessories are accommodated in the high-voltage distribution boards.

FIG. 1 shows a high-voltage distribution board 10 according to the related art.

Compartments of the distribution board 10 may include a circuit breaker compartment 11 where a circuit breaker is accommodated, a bus bar compartment 13 through which draw-out bus bars or cables pass, a transformer compartment 14 where a potential transformer 25 is accommodated, and a low-voltage device compartment 15 where low-voltage device is accommodated. High-voltage distribution boards are usually constructed in a plurality of stages.

At this time, it is common that respective compartments, frames, electric equipment, or internal components inside the compartments are coupled in a fastening manner using bolts.

Here, low-voltage devices, such as a relay and a molded case circuit breaker, are installed in the low-voltage device compartment 15. The low-voltage device compartment 15 is provided as a separate, independent space in the circuit breaker compartment 11.

In this case, when the low-voltage device compartment 15 is installed separately, the height of the distribution panel 10 more increases.

FIG. 2 shows a distribution board according to another embodiment of the related art.

Here, the distribution board 30 may be considered as a circuit breaker compartment. As in the previous embodiment, a circuit breaker 21 is installed in the distribution board 30. The circuit breaker 21 is usually drawn inward by being loaded on a transfer device 22.

In this embodiment, a separate low-voltage device compartment is not provided within the distribution board 30, but a low-voltage device panel 35 is arranged above the circuit breaker 21, such that a low-voltage device 38, such as a molded case circuit breaker, is installed.

The low-voltage device panel 35 is provided above the circuit breaker 21. A cable duct 36 for wiring is installed at upper and lower ends of the low-voltage device panel 35.

In this embodiment, an occupied space is reduced compared to the previous embodiment because a separate low-voltage device compartment is not provided. However, the height of the distribution board still increases because a space is required for the low-voltage device panel 35.

In some embodiments, when installing and maintaining the low-voltage device in the low-voltage device compartment or the low-voltage device panel according to the related art, it is not easy because an equipment board is installed in an inner corner of the distribution board or circuit breaker compartment.

When the low-voltage device is exposed, a secondary accident may occur due to an arc generated in the circuit breaker in the event of an accident.

### SUMMARY

The present disclosure has been made to solve the above-mentioned problems, and an aspect of the disclosure is to provide a distribution board having a drawer-type device panel that facilitates a wiring work while minimizing an occupied space.

According to an embodiment of the disclosure, a distribution board having a drawer-type device panel includes: a distribution board where power equipment is installed; a drawer part enclosure plate installed on one surface of the distribution board and including an accommodating portion; and a drawer plate inserted into the drawer part enclosure plate to be open and closed, wherein a height of a rear surface part of the drawer plate is formed lower than a height of a front surface part so that the drawer plate is rotatable downward in a partially pulled-out state.

The drawer part enclosure plate is formed in a box shape with upper and front surfaces open.

The drawer part enclosure plate is coupled to a top plate of the distribution board.

A supporter is arranged on an upper end portion of a front surface of the drawer part enclosure plate.

A fixing bar is inclinedly arranged on a rear surface part of the supporter.

A plurality of support protrusions protrude from a bottom surface of the drawer part enclosure plate.

The drawer plate includes a front surface part, a bottom part, and a rear surface part.

A plurality of fastening holes are formed in the front surface part of the drawer plate so as to install a low-voltage device including a molded case circuit breaker or a switch.

Wing portions are formed on the front surface part of the drawer plate to extend to opposite sides.

Cut portions are formed on opposite side surfaces of the bottom part of the drawer plate.

A first cable duct is installed on the rear surface part of the drawer part enclosure plate, and a second cable duct is arranged on the bottom part of the drawer plate.

The first cable duct or the second cable duct is formed in a ‘⊏’ shape, and a plurality of first cable holes or a plurality of second cable holes are formed in upper and lower surface parts of the first cable duct or front and rear surface parts of the second cable duct.

A length of the rear surface part of the drawer plate is equal to a length between the cut portions.

By a distribution board having a drawer-type device panel according to an embodiment, a drawer-type panel for a low-voltage device is provided and thus occupies a less space in the distribution board. That is, a drawer part enclosure plate is provided, and a drawer plate inserted into the drawer part enclosure plate is provided, so that a separate working space is not required.

In particular, the height of a space where the low-voltage device is installed can be lowered. This can result in reducing the height of the distribution board.

The device panel is provided as a drawer type to be open and closed, which is advantageous for installation and maintenance work.

The Low-voltage device is protected by being built in the drawer-type device panel, thereby suppressing a secondary accident, such as a fire caused by arcs.

### BRIEF DESCRIPTION OF THE DRAWINGS

FIG. 1 is a side view of a multi-stage distribution board according to an embodiment of the related art.

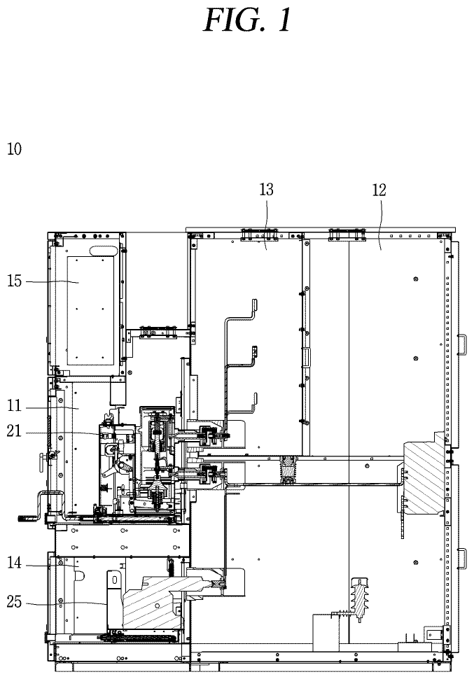

FIG. 2 is a front view of a distribution board according to another embodiment of the related art.

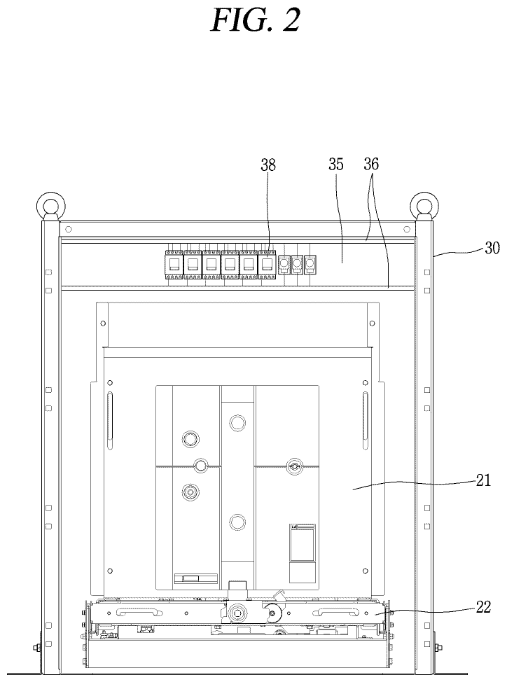

FIG. 3 is a front view of a distribution board according to an embodiment of the disclosure. It is shown with a front plate removed so that the interior is visible.

FIG. 4 is a partial side view of a distribution board according to an embodiment of the disclosure. It is shown with a side plate removed so that the interior is visible.

FIGS. 5 and 6 are a front view and a perspective view of a drawer-type device panel to which a distribution board according to an embodiment of the disclosure is applied.

FIG. 7 is a view of an open state of a drawer plate in FIG. 6.

FIG. 8 is an exploded perspective view of FIG. 6.

FIG. 9 is a partial side view of a distribution board according to an embodiment of the disclosure. The drawer plate is in an open state.

### DETAILED DESCRIPTION

Hereinafter, preferred embodiments of the disclosure will be described with reference to the attached drawings. However, embodiments of the disclosure will be described in more detail with reference to the accompanying drawings so as to allow those skilled in the art to easily implement the disclosure, and it should be understood that the technical idea and scope of the disclosure are not limited to those preferred embodiments and drawings.

The terms “member” or “part” used herein to refer to components are not used for any limiting purpose and may be omitted.

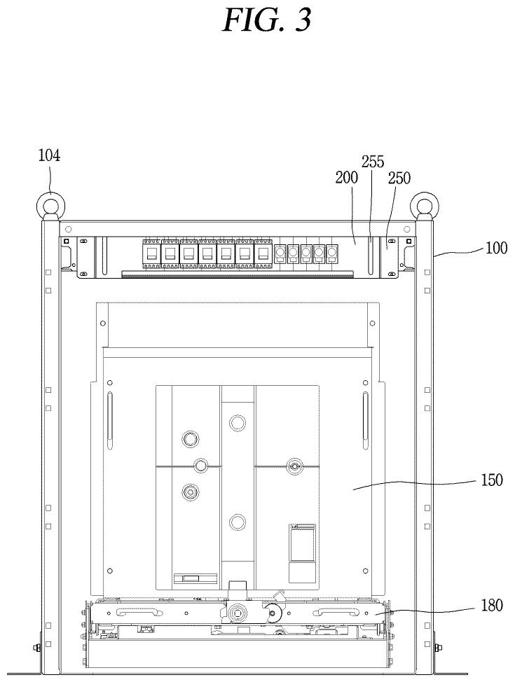

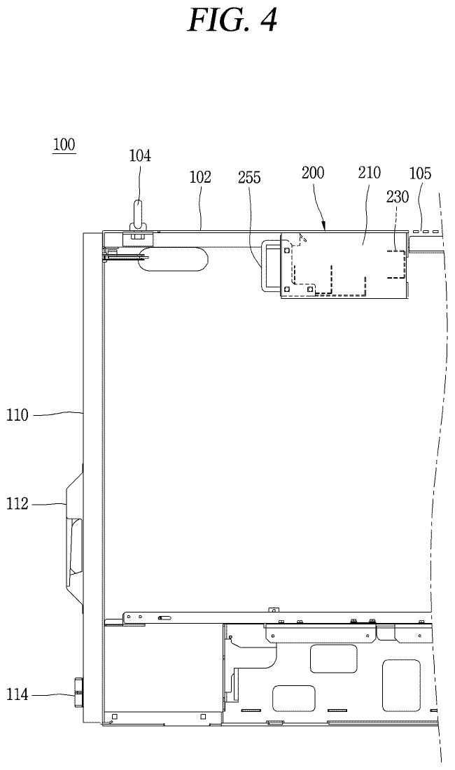

FIG. 3 is a front view of a distribution board according to an embodiment of the disclosure, and FIG. 4 is a partial side view of a distribution board according to an embodiment of the disclosure. FIG. 3 shows a state in which a front surface part has been removed, and FIG. 4 shows a state in which a side surface part has been removed. Hereinafter, a distribution board 100 having a drawer-type device panel 200 according to each embodiment will be described in detail with reference to the drawings.

A distribution board having a drawer-type device panel according to an embodiment of the disclosure includes: a distribution board 100 in which power equipment 150 is installed; a drawer part enclosure plate 210 installed on one surface of the distribution board 100 and having an accommodating portion 211; and a drawer plate 250 inserted into the drawer part enclosure plate 210 to be open and closed, and a height of a rear surface part 265 of the drawer plate 250 is lower than a height of a front surface part 252 so that the drawer plate 250 can rotate downward in a partially drawn-out state.

The distribution board 100 is arranged. Here, the distribution board 100 may also be a circuit breaker room or a cradle. In other words, a distribution board is a compartmentalized structure, in which power equipment can be installed, in a comprehensive sense.

The distribution board 100 may be formed in a box shape. The distribution board 100 may be formed as a metal case or a synthetic resin case.

The distribution board 100 may be assembled by connecting each surface. For example, an upper surface, a lower surface, a front surface, a rear surface, and opposite side surfaces may be prepared, and coupled by fastening members, thereby manufacturing the distribution board.

The distribution board 100 has power equipment installed inside. An example of such power equipment 150 may be power equipment, such as the circuit breaker illustrated in FIG. 3, which may generate an arc in the event of an accident.

A ventilator 105 is formed through an upper portion of the distribution board 100. The ventilator 105 may include a plurality of holes. The ventilator 105 may be located at a rear portion on an upper surface of the distribution board 100.

A ring portion 104 which is a device for lifting may be installed on each corner on the upper portion of the distribution board 100.

A distribution board door 110 is installed on the front surface of the distribution board 100. A door handle part 120 is provided on one side of the distribution board door 110.

A working hole 114, through which a lead screw (not shown) for inserting and withdrawing a circuit breaker may be inserted, is arranged on a lower end portion of the distribution board door 110. The lead screw is rotated through the working hole 114 to move a transfer device 180 forward and backward.

The circuit breaker 150 may be drawn in and out while being loaded on the transfer device 180.

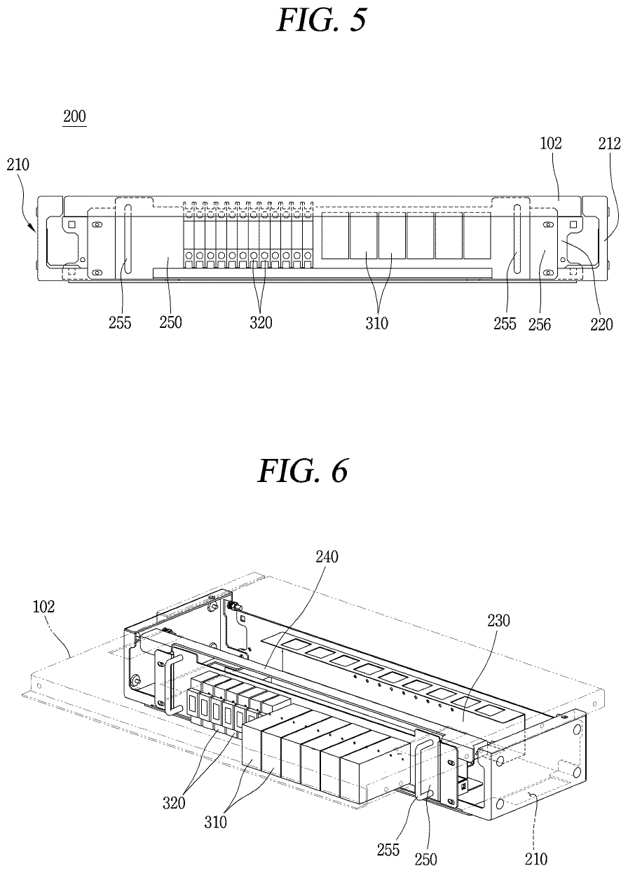

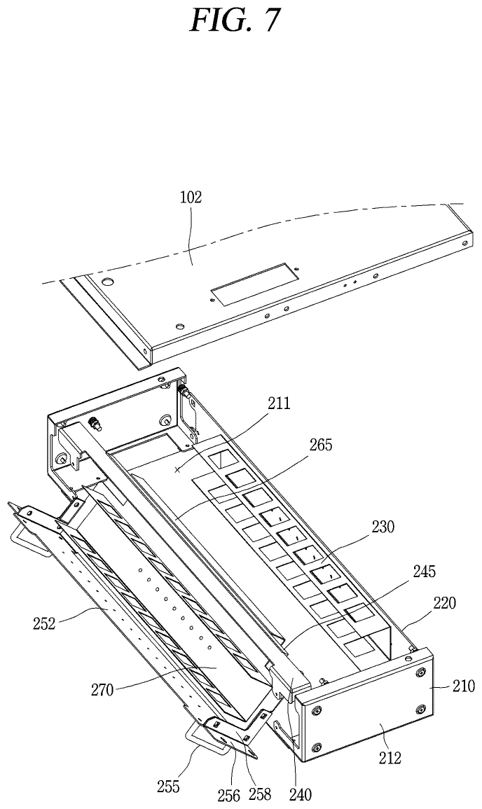

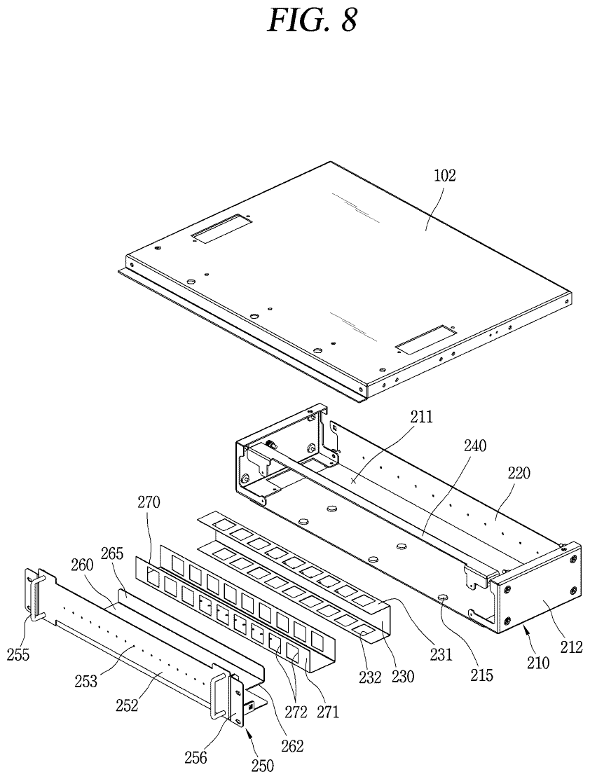

FIGS. 5 and 6 are a front view and a perspective view of a drawer-type device panel to which a distribution board according to an embodiment of the disclosure is applied. FIG. 7 is a view of an open state of a drawer plate in FIG. 6. FIG. 8 is an exploded perspective view of FIG. 6.

A drawer-type device panel 200 is provided. The drawer-type device panel 200 is provided to facilitate the installation of a low-voltage device, such as a relay or a circuit breaker.

The drawer-type device panel 200 includes a drawer part enclosure plate 210 and a drawer plate 250 accommodated in the drawer part enclosure plate 210.

The drawer part enclosure plate 210 may be formed in a box shape with upper and front surfaces open. Accordingly, the drawer part enclosure plate 210 includes an accommodating portion 211 formed inside. The drawer plate 250 may be inserted into the accommodating portion 211.

The drawer part enclosure plate 210 is coupled to a top plate 102 of the distribution board 100. For example, the drawer part enclosure plate 210 may be coupled to the top plate 102 of the distribution board 100 in such a way that side surface parts 212 of the drawer part enclosure plate 210 are coupled to side surfaces of the top plate 102 of the distribution board 100.

A first cable duct 230 is installed on a rear surface part 220 of the drawer part enclosure plate 210.

The first cable duct 230 may be formed as a ‘⊏’-shaped plate. A plurality of first cable holes 232 for installing cables are formed in upper and lower surface parts 231 of the first cable duct 230. This may facilitate installation and connection of various types of devices and cables.

A supporter 240 is arranged on an upper portion of the front surface of the drawer part enclosure plate 210. The supporter 240 may have a length that reaches opposite side surface parts 212 of the drawer part enclosure plate 210.

The supporter 240 may be formed as a straight or ‘¬’-shaped plate.

The supporter 240 may be coupled to the opposite side surface parts 212 of the drawer part enclosure plate 210 or fixedly installed on the top plate 102 of the distribution board 100.

A fixing bar 245 is inclinedly formed on a rear surface part of the supporter 240 (see FIG. 7). The fixing bar 245 is formed with a certain length along a longitudinal direction of the supporter 240. The fixing bar 245 temporarily fixes the drawer plate 250 to suppress separation of the drawer plate 250 and facilitate work on a low-voltage device.

The fixing bar 245 is preferably inclined at an angle ranging from 30 to 60 degrees relative to the top plate 102.

A plurality of supporting protrusions (embossed portions) 215 protrude from a bottom surface of the drawer part enclosure plate 210. The support protrusions 215 suppress the drawer plate 250 from being in surface-contact with the bottom surface when the drawer plate 250 is inserted into the drawer part enclosure plate 210, thereby facilitating the insertion of the drawer plate 250. Therefore, no separate rail or inlet device is required.

The drawer plate 250 is arranged. The drawer plate 250 may be pushed into or pulled out of the drawer part enclosure plate 210 in an opening and closing manner. The low-voltage device is installed in the drawer plate 250.

The drawer plate 250 includes a front surface part 252, a bottom part 260, and a rear surface part 265.

A plurality of fastening holes 253 are formed in the front surface part 252 of the drawer plate 250 to allow installation of the low-voltage device, such as a circuit breaker 310 or a switch 320. The low-voltage device may also be installed on the front surface part using brackets, and the like.

Handles 252 are arranged on opposite sides of the front surface part 252 of the drawer plate 250. A user may pull or push the handles 255 to draw the drawer plate 250 into or out of the drawer part enclosure plate 210, and rotate the drawer plate 250 downward in the state that the drawer plate 250 has been drawn out. This may increase a gap from the upper plate 102 of the distribution board 100, thereby creating a working space.

The drawer plate 250 includes wing portions 256 extending from opposite sides of the front surface part 252. When the drawer plate 250 is fully inserted into the drawer part enclosure plate 210, the wing portions 256 come into contact with the supporter 240. That is, when the wing portions 256 come into contact with the supporter 240, the insertion of the drawer plate 250 is completed.

A reinforcing member 258 connecting the bottom part 260 and the front surface part 252 is arranged on the drawer plate 250.

Cut portions 262 are formed on opposite side surfaces of the bottom part 260 of the drawer plate 250. The cut portions 262 formed on the opposite side surfaces of the rear surface part 265 make the rear surface part 265 shorter than the bottom part 260. This suppresses an occurrence of interference when the drawer plate 250 is drawn out from the drawer part enclosure plate 210.

The rear surface part 265 of the drawer plate 250 may have a length corresponding to a length between the cut portions 262 on the opposite side surfaces of the bottom part 260.

A height of the rear surface part 265 of the drawer plate 250 is lower than a height of the front surface part 252. Accordingly, the user can pull out and rotate the drawer plate 250. That is, a gap is secured that allows the user to pull the drawer plate 250 out of the drawer part enclosure plate 210 and push the drawer plate 250 down.

When the user pulls the drawer plate 250 out of the drawer part enclosure plate 210 and pushes the drawer plate 250 down, the rear surface part 265 rises and is caught on the fixing bar 245 of the supporter 240. Accordingly, the drawer plate 250 is restricted from being further drawn out and fixed in a downwardly-pushed state. Accordingly, the user can perform work for installing the low-voltage device on the drawer plate 250.

A second cable duct 260 is arranged on the bottom part 260 of the drawer plate 250.

The second cable duct 270 may be formed as a ‘⊏’-shaped plate. A plurality of second cable holes 272 for installing cables are formed in front and rear surface parts 271 of the second cable duct 270. This may facilitate installation and connection of various types of devices and cables.

Various relays 310 or switches 320 may be installed on the front surface part 252 of the drawer plate 250.

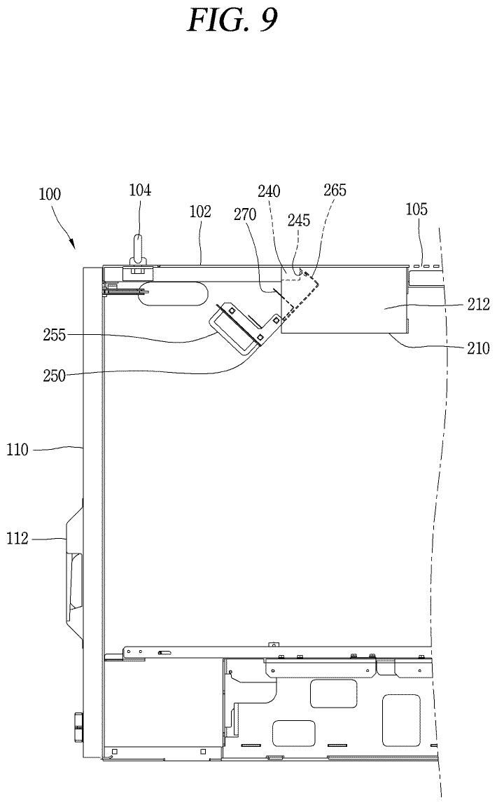

Hereinafter, operations of a distribution board having a drawer-type device panel according to an embodiment will be described. The description will be given with reference to FIGS. 4 and 9. FIGS. 4 and 9 are partial side views of a distribution board according to an embodiment. It is shown with a side plate removed so that the interior is visible. FIG. 4 shows the drawer plate 250 in a closed state, and FIG. 9 shows the drawer plate in an open state.

The user may pull the handles 255 to draw the drawer plate 250 out of the drawer part enclosure plate 210. The user may pull the drawer plate 250 by a certain distance and then lower the drawer plate 250. The rear surface part 265 of the drawer plate 250 is formed lower than the front surface part 252 of the drawer plate 250. Therefore, as the rear surface part 265 of the drawer plate 250 rises, the front surface part 252 of the drawer plate 250 is lowered. The rear surface part 265 of the drawer plate 250 is brought into contact with the fixing bar 245 of the supporter 240 and stops moving. That is, the drawer plate 250 is maintained in the lowered state while being supported by the fixing bar 245. The user may easily perform work on a device, such as a molded case circuit breaker or a switch, on the drawer plate 250.

According to a distribution board having a drawer-type device panel according to an embodiment, a drawer-type low-voltage device panel is provided, thereby occupying a less space inside the distribution board. In particular, the height of a space where the low-voltage device is installed may be lowered. This may reduce the height of the distribution board.

The device panel is provided as a drawer type to be open and closed, which is advantageous for installation and maintenance work.

Low-voltage devices are protected by being built in the drawer-type device panel, thereby suppressing a secondary accident, such as a fire caused by arcs.

While the above-described embodiments illustrate the best embodied state for implementing the disclosure, it will be understood by those skilled in the art that various changes and modifications may be made without departing from the scope of the disclosure. Therefore, these embodiments are not intended to limit the technical idea of the disclosure but are merely illustrative. Therefore, it should be understood that the scope of the technical idea of the disclosure is not limited by these embodiments. That is, the scope of protection of the present disclosure should be construed according to the appended claims, and all technical ideas within the scope of equivalents thereof should be construed as being included in the scope of the present disclosure.

### Description of Reference Numerals

100 Distribution board
102 Top plate
110 Distribution board door
150 Power equipment
180 Transfer device
200 Drawer-type device Panel
210 Drawer part enclosure Plate
211 Accommodating portion
220 Rear surface part
230 First cable duct
240 Supporter
245 Fixing bar
250 Drawer plate
252 Front surface part
255 Handle
256 Wing portion
260 Bottom part
265 Rear surface part
270 Second cable duct

1. A distribution board having a drawer-type device panel, the distribution board comprising:
a distribution board where power equipment is installed;
a drawer part enclosure plate installed on one surface of the distribution board and comprising an accommodating portion; and
a drawer plate inserted into the drawer part enclosure plate to be open and closed, wherein a height of a rear surface part of the drawer plate is formed lower than a height of a front surface part so that the drawer plate is rotatable downward in a partially drawn-out state.

2. The distribution board of claim 1, wherein the drawer part enclosure plate is formed in a box shape with a front surface open.

3. The distribution board of claim 1, wherein the drawer part enclosure plate is coupled to a top plate of the distribution board.

4. The distribution board of claim 1, wherein a supporter is arranged on an upper end portion of a front surface of the drawer part enclosure plate.

5. The distribution board of claim 4, wherein a fixing bar is inclinedly arranged on a rear surface part of the supporter.

6. The distribution board of claim 1, wherein a plurality of support protrusions protrude from a bottom surface of the drawer part enclosure plate.

7. The distribution board of claim 1, wherein the drawer plate comprises a front surface part, a bottom part, and a rear surface part.

8. The distribution board of claim 7, wherein a plurality of fastening holes are formed in the front surface part of the drawer plate so as to install a low-voltage device comprising a molded case circuit breaker or a switch.

9. The distribution board of claim 7, wherein wing portions are formed on the front surface part of the drawer plate to extend to opposite sides.

10. The distribution board of claim 7, wherein cut portions are formed on opposite side surfaces of the bottom part of the drawer plate.

11. The distribution board of claim 7, wherein a first cable duct is installed on the rear surface part of the drawer part enclosure plate, and a second cable duct is arranged on the bottom part of the drawer plate.

12. The distribution board of claim 11, wherein the first cable duct or the second cable duct is formed in a ‘227 ’ shape, and a plurality of first cable holes or a plurality of second cable holes are formed in upper and lower surface parts of the first cable duct or front and rear surface parts of the second cable duct.

13. The distribution board of claim 10, wherein a length of the rear surface part of the drawer plate is equal to a length between the cut portions.
